(19) United States
(12) Patent Application Publication
(10) Pub. No.: US 2011/0178643 A1
(43) Pub. Date: Jul. 21, 2011

(54) SYSTEM, METHOD, AND COMPUTER READABLE MEDIUM FOR REGULATING DEMAND FOR ELECTRICITY

(76) Inventor: Malcolm Stuart Metcalfe, West Vancouver (CA)

(21) Appl. No.: 13/121,672

(22) PCT Filed: Sep. 29, 2009
(86) PCT No.: PCT/CA09/01374

§ 371 Date: Mar. 29, 2011

(30) Foreign Application Priority Data
Sep. 29, 2008 (US) 61/100.908
Feb. 27, 2009 (US) 61/156359

(51) Int. Cl. G06F 1/32; G05D 23/19

(52) U.S. Cl. 700/276

(57) ABSTRACT

A system, method, and computer readable medium for managing energy supplied by an electricity vendor to a facility heatable by electrical and non-electrical means are disclosed. The method, for example, involves determining a requested load from a vendor as the difference between a target load of the vendor and a current load on the vendor imposed by the facility; and when the requested load is greater than zero, increasing heating of the facility by electrical means thereby increasing a current heating electrical load of the facility by at least a portion of the requested load; and decreasing heating of the facility by non-electrical means thereby decreasing a current heating non-electrical load of the facility.

### FIELD OF THE INVENTION

The present invention relates generally to managing energy usage in a facility. More specifically, the present invention relates to an electrical utility managing electricity usage in one or more facilities.

### BACKGROUND OF THE INVENTION

Most electric utilities in North America generate electrical energy using power plants that operate by burning fossil fuels, such as coal, or through nuclear fission. Such power plants are able to generate power on a continuous basis for extended periods of time, but have the disadvantage that their power output cannot be quickly increased or decreased. Furthermore, any excess power generated using coal or nuclear power plants generally cannot be economically stored by a utility for later use by the utility's customers. Consequently, if not used by the utility's own customers, such excess power must be sold on the open market, often at a very low price. It is essential that generation and load (including export sales or purchases) are in balance at all times.

Electrical utilities adjust generation to match demand on a continuous basis. The electrical load that the electric utility supplies typically fluctuates throughout the day, with the lowest demand occurring at night, and the highest demand occurring in the late afternoon and early evening. Generating facilities that can change output rapidly are either relatively scarce (hydroelectric—8% of US total capacity), or are inefficient and expensive to operate (simple gas turbine generators). During times of low demand, because most utilities in North America have excess power available as a result of their relying on coal or nuclear power plants, the cost of electricity is relatively low and selling excess power is uneconomical. During times of high demand, because additional capacity cannot quickly be brought online or may be available only by using high cost generating facilities, the marginal cost of electricity is relatively high and buying additional power to meet demand can be very expensive. While a utility can generate additional electricity during periods of high demand to meet marginal demand in excess of normal generation capacity, such generation is usually done using inefficient gas turbine equipment, and the power that results is therefore usually relatively expensive. Electric utilities consequently have an incentive to generate a constant level of power that is sufficient to meet their customers' power needs during periods of high demand so as to avoid having to purchase or generate expensive power, but at the same time have a disincentive to avoid overgeneration because excess power cannot be stored or sold economically during periods of low demand. In other words, electric utilities have great incentive to minimize the difference between the power consumed during periods of high demand versus the power consumed during periods of low demand.

The utility, in fact, must meet two requirements:
Load changes that occur throughout the typical day—the load increases typically about 60% from the low level at night to the afternoon peak, before falling again. This type of load change is generally managed using a dispatch system that selects the lowest cost sources of generation at least twice each hour as well as a variety of systems that shed load during peak hours.
Load changes that occur randomly and must be addressed quickly to ensure an ongoing balance are addressed by an Automatic Generation Control (AGC) system that initiates changes to specified control generators as often as every 4 seconds. The AGC system has typically used a small number of generators that have fast response capability to perform this task.

Both of these methods of control are known in the art. An example of a load shedding system involves a utility manually calling consumers during periods of high demand and asking them to shut off certain loads for a period of time. This method is disadvantageous in that it relies on human interaction and is therefore slow and prone to error, and in that it requires a load that can either be shut off during periods of high demand or powered with an alternative energy source. Peak shaving generally is disadvantageous in that customers may not have loads that can easily be powered using alternative energy sources or shut off during periods of high demand. Furthermore, utilities typically pay their consumers to participate in peak shaving programs, at a cost that is often in excess of $0.15/kWh saved.

With the specific exception of load shedding, all utility controls have generally relied on controlling generation rather than load. As the utilities have grown, this method has become more and more difficult. In recent times, the utilities have focused some attention on the use of Load Based Regulation (LBR) systems. Almost all of these systems have used either a form of energy storage, or a load that can be controlled to provide the utility with the capacity to do the short term AGC control.

Accordingly, it would be advantageous to develop at least one of a new system, method, or memory that allows electric utilities to better regulate the demand for electricity.

### SUMMARY OF THE INVENTION

According to one aspect of the invention, there is provided a method of managing energy supplied by an electric utility to a customer facility that is heatable by electrical and non-electrical heating means, comprising: determining a desired cumulative instantaneous electrical load of the utility (“target load”); determining a total instantaneous electrical load on the utility imposed by the facility (“current load”); determining a requested load from the utility as the difference between the target load and current load; when the requested load is positive, increasing heating of the facility by the electrical heating means to meet at least part of the requested load and decreasing heating of the facility by the non-electrical heating means; and when the requested load is negative, decreasing heating of the facility by the electrical heating means to reduce at least part of a requested load deficit and increasing heating of the facility by the non-electrical heating means. The desired target load can be set equal to a peak load on the utility imposed by the facility in a selected time period.

The method can further comprise determining a marginal cost of heating the facility by the electrical heating means and a marginal cost of heating the facility by the non-electrical heating means, and increasing the heating of the facility by the electrical heating means only when the marginal cost of heating by the non-electrical heating means is greater than the marginal cost of heating by the electrical heating means. The method can further comprise determining a peak billed demand threshold of the facility in a selected billing period and a total electrical demand of the facility and increasing the heating of the facility by electrical heating means only when the total electrical demand of the facility is less than the peak billed demand threshold of the facility. All electrical consumption by the facility can contribute to determination of the peak billed demand threshold of the facility. Alternatively, only electrical consumption by the facility for non-heating purposes can contribute to determination of the peak billed demand threshold.

Increasing heating of the facility by the electrical heating means increases a current heating electrical load of the facility, and decreasing heating of the facility by the non-electrical heating means decreases a current heating non-electrical load of the facility. When the requested load is greater than the current heating non-electrical load, the method may further include increasing heating of the facility by the electrical heating means thereby increasing the current heating electrical load of the facility by the current heating non-electrical load; and decreasing heating of the facility by non-electrical heating means thereby decreasing the current heating non-electrical load to zero. Additionally, when the requested load is not greater than the current heating non electrical load, the method may further include increasing heating of the facility by the electrical heating means thereby increasing the current heating electrical load by the requested load; and decreasing heating of the facility by the non-electrical heating means thereby decreasing the current heating non-electrical load by the requested load.

The method may also include determining whether the requested load of the electricity vendor is greater than the current heating non-electrical load of the facility only when the difference between the peak billed demand threshold and the facility total electrical demand is greater than the current heating non-electrical load.

The method may also include determining whether the requested load is greater than a difference between the peak billed demand threshold and the current heating electrical load if the difference between the peak billed demand threshold and the facility total electrical demand is not greater than the current heating non-electrical load; and then when the requested load is greater than the difference between the peak billed demand threshold and the current heating electrical load: increasing heating of the facility by electrical heating means thereby increasing the current heating electrical load to the peak billed demand threshold; and decreasing heating of the facility by non-electrical heating means thereby decreasing the current heating non-electrical load by the difference between the peak billed demand threshold and the current heating electrical load.

When the requested load is not greater than the difference between the peak billed demand threshold and the current heating electrical load, the method may include increasing heating of the facility by electrical heating means thereby increasing the current heating electrical load by the requested load; and decreasing heating of the facility by non-electrical heating means thereby decreasing the current heating non-electrical load by the requested load.

The method may also include determining whether the difference between the peak billed demand threshold and the facility total electrical demand is greater than the current heating non-electrical load only when the peak billed demand threshold is greater than the facility total electrical demand. Additionally, the method may also include determining whether the peak billed demand threshold is greater than the facility total electrical demand only when a marginal cost of electricity is less than a marginal cost of fuel.

According to a further aspect of the invention, there is provided a computer readable medium having encoded thereon steps and instructions for execution on a processor to manage energy supplied to a facility, the steps and instructions including the method as described above.

According to another aspect of the invention, there is provided a system for managing energy supplied by an electric utility to a customer facility. The system comprises a server having inputs communicative with the facility to receive a total instantaneous electrical demand of the facility, and communicative with the utility to receive a desired cumulative electrical load of the utility. The system also comprises a processor communicative with the inputs and having a memory having recorded thereon statements and instructions for execution by the processor to perform a method as described above. The system also comprises outputs communicative with the facility to control heating of the facility by non-electrical means and electrical means.

The utility can include an automatic generation control system, in which case the server inputs are communicative with the utility to receive an area control error from the automatic generation control system, and the processor is programmed to determine a target load of the utility from the area control error and perform the method as described above to control the heating of the facility by electrical means to meet any additional generation required by the automatic generation control system.

According to another aspect of the invention, there is provided a method of providing a spinning reserve to an electric utility having a customer facility that is heatable by electrical and non-electrical heating means. The method comprises: heating the facility by electrical heating means using electricity from the utility at a current heating electrical load that is at least as high as a maximum selected spinning reserve; receiving a spinning reserve request from the utility; then decreasing heating of the facility by the electrical heating means until the current heating electrical load is decreased by the requested spinning reserve, and increasing heating of the facility by the non-electrical heating means.

There are three general areas where a vendor (electric utility or Independent System Operator (ISO)) may benefit. The system may be used as a dispatchable load, increasing system load during off peak periods when surplus electricity is likely to be sold to other utilities at a very low price. It may also be used to provide Regulation Services, allowing the utility to use a fast responding load for AGC Control, instead of a generator, reducing system costs. Finally, it may also be used as a “Spinning Reserve” source, allowing the utility to reduce load rapidly, without disturbing customers, in the event of a system disturbance when generation has been lost.

One benefit of the invention is that, as opposed to peak shaving wherein the vendor must pay consumers to reduce electrical load, the vendor can make money according to the present invention by selling electricity to its own consumers in excess of the price the electricity would otherwise fetch on the open market during a period of low demand.

An additional benefit of the invention is that it allows the vendor to increase the base electrical load it has to satisfy. This is beneficial in that the vendor can satisfy an increased base electrical load through relatively non-polluting and inexpensive means of electricity generation, such as nuclear power, as opposed to being forced to satisfy large periodic spikes in electrical load using expensive, relatively polluting forms of generation such as generating power using gas turbines.

An additional benefit of the present invention is that it can make unpredictable, variable output sources of electricity, such as wind power, economically viable. If the vendor can quickly increase and decrease electrical load as desired, any sudden increases or decreases in electricity generation that result from wind power, for example, can be sold to the vendor's customers.

A benefit of the aspects of the present invention that utilize electrical means to affect the current heating electrical load of the facility is that such electrical means can be relatively inexpensive and consequently can be easily adopted and installed into the facility. For example, a relatively inexpensive electric boiler can be purchased as an electrical means that is used to affect the current heating electrical load of the facility, with the added benefit that use of the electric boiler can offset use of non-electrical heating means such as a fuel boiler, thereby reducing fossil fuel usage.

A benefit of the aspects of the invention that utilize electrical and non-electrical means to affect the current heating electrical and non-electrical loads of the facility, respectively, is that the facility total heating load can remain constant regardless of how facility heating is apportioned between the electrical and non-electrical means. Consequently, a change in the current heating electrical load does not negatively affect the total heating provided to the facility.

### BRIEF DESCRIPTION OF THE DRAWINGS

FIG. 1 is a block diagram of inputs and outputs to and from a server that is coupled to both an electric utility and to one or more customer facilities, according to a first embodiment of the invention;

FIG. 2(a) is an exemplary graph of electrical energy that is supplied by the utility to various facilities over a given time period;

FIG. 2(b) is an exemplary graph of electrical energy that is supplied by the utility to various facilities over a given time period, according to the first embodiment of the invention;

FIG. 2(c) is an exemplary graph of electrical energy consumption by any given facility over a given time period;

FIG. 2(d) is an exemplary graph of electrical energy consumption by any given facility over a given time period, according to the first embodiment of the invention;

FIG. 3 is a block diagram of a system installed at a facility for alternating between electricity and fuel heating and that is communicative with the server depicted in FIG. 1;

FIG. 4 is a flowchart depicting the steps in an algorithm whereby the server responds to a requested increase in electrical energy consumption requested by the utility, according to the first embodiment of the invention;

FIG. 5 is a flowchart depicting the steps in an algorithm whereby the server responds to a requested decrease in demand requested by the utility, according to a second embodiment of the invention;

FIG. 6 is a flowchart depicting the steps in an algorithm whereby the server responds to an increase in demand requested by the utility, according to a third embodiment of the invention; and

FIG. 7 is a schematic of the utility coupled to the server and the facilities, according to an embodiment of the invention.

### DETAILED DESCRIPTION OF AN EXEMPLARY EMBODIMENT

In contrast to “peak shaving,” an alternative method of regulating demand such that the difference between power usage during periods of high and low demand is reduced is “valley filling”. Valley filling in the context of an electrical utility relates to increasing the electrical load demanded by the utility's customers during off-peak periods such that the difference between the “peak electrical load” (the maximum amount of power that is utilized by the utility's customers at any given time over a given time period) and the “base electrical load” (the minimum amount of power that is consistently utilized by the utility's customers over the time period) is reduced. In one embodiment, such valley filling involves utilizing the electricity that is generated by the utility but not consumed by the utility's customers. Some utilities must sell this excess electricity on the open market at a discounted price (which is often below the marginal cost of generating this excess electricity) because their generation technology cannot economically adjust electrical output to follow the load demanded by its customers. Therefore, the utility generates electricity at a relatively steady state, and “valleys” below the steady state output are created because of the fluctuating demand from the customers. The embodiments described herein can be used, for example, to utilize this excess electricity, i.e. “filling in the valley”, to heat the space or water of customer facilities instead of or in conjunction with heating by fossil fuels.

In some embodiments, electric heaters such as electric boilers or furnaces are installed in each facility to complement existing non-electric heaters, such as gas boilers or furnaces, and the electric furnaces can be operated to produce space heating and the electric boilers are operated to produce space heating and/or domestic hot water.

In the embodiments that will be described below, there is provided an algorithm, stored on a memory and executable by a processor, for managing energy supplied by an electric utility to a customer facility that is heatable by electrical and non-electrical heating means, and in particular, to operate the electrical and non-electrical heating means in a manner that is economic for the utility, and also preferably economic for the facility. This algorithm is hereinafter referred to as the “utility valley filling algorithm”.

### System Overview

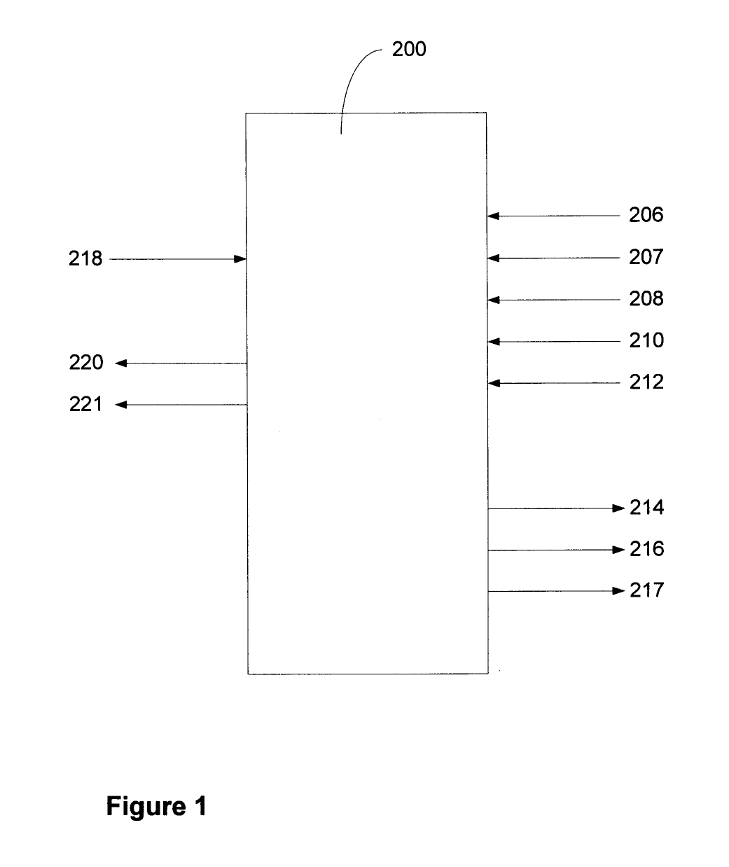

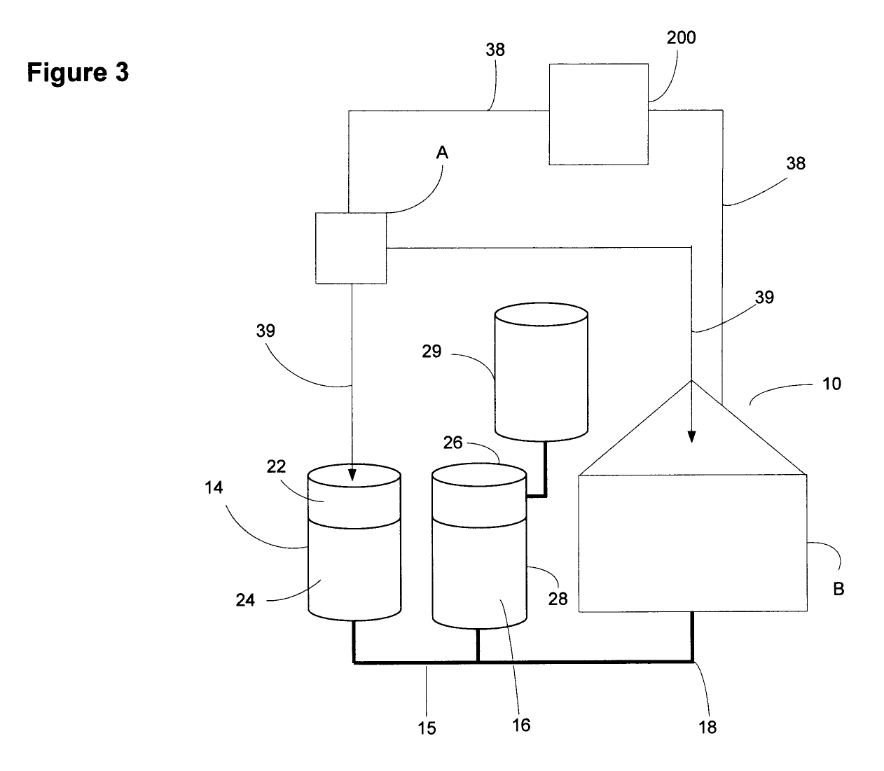

Referring to FIGS. 1 and 3 and according to a first embodiment, there is provided a server 200 that is communicative with an electric utility A and a customer facility B (illustrated by communication lines 38 in FIG. 3), and that can be used to implement the utility valley filling algorithm. Such communication can be via phone lines, cable, or other communication means as known in the art. Exemplary servers includes those that are supplied by IBM or Sun Microsystems, for example. The server 200 has a processor with a memory programmed to execute the utility valley filling algorithm.

The facility B in this embodiment is a building that requires heat and electricity. The facility B is supplied electricity from the utility A via power lines 39 to power electrically-powered fixtures and devices (not shown) found within the facility B. Installed at, in or near the facility B are components which use electricity and fuel to heat the facility B, as depicted in FIG. 3, namely an electric heating assembly 14, and a fuel heating assembly 16. The electric heating assembly 14 is an example of an electrical means of heating the facility B, while the fuel heating assembly 16 is an example of a non-electrical means for heating the facility B. The electric and fuel heating assemblies 14, 16 heat a heat transfer fluid 15 which transfers the heat into the facility; examples of suitable heat transfer fluids include water, air, and other heatable fluids known in the art for storing and transferring heat, e.g. refrigerants. The heat transfer fluid 15 is conveyed between the facility B and the heating assemblies 14, 16 by heat transfer conduit 18, which can be a pipe for carrying water or other heat transfer liquid, or an air duct for carrying air.

The electrical heating assembly 14 is comprised of an electrical heating element 22 and an electrical heat storage device 24. The heating element 22 can be one or more electric furnaces to heat air and/or one or more electric boilers to heat water. Instead or in addition to the electric furnace, the electric boiler can be coupled to a heat exchanger to heat air. The electrical heat storage device 24 can be a container for storing heated water, such as the boiler's water tank. Similarly, the fuel heating assembly 16 is comprised of a fuel heating element 26 and a fuel heat storage device 28, wherein the fuel heating element 26 can be one or more fuel furnaces and/or fuel boilers, and the fuel heat storage device 28 can be a heated water storage container. One or more components of the electrical and fuel heating assemblies 14, 16 can pre-exist in the facility B, in which case the server 200 can instruct the facility B to use such components to manage electricity and fuel used by the facility B. Alternatively, one or more of these components can be installed if not already in the facility B for use by the server 200. Each of the electrical and fuel heating assemblies 14, 16 can have an SCR controller to allow continuous adjustment over the entire operating range of the heating assemblies 14, 16, and each of the heating assemblies 14, 16 can also have a revenue certified meter, or “smart meter”, that provides readings such as current kW, kVAR, voltage and system frequency.

The utility A supplies electricity via the power line 39 to the electric heating element 22 of the electric heating assembly 14. The facility B has a fuel storage tank 29 for storing fuel for use by the fuel heating assembly 16. The fuel can be natural gas, butane, propane, heating oil or any other heating fuel as is known in the art. Fuel is purchased from a fuel vendor (not shown) who sends a tanker (not shown) to replenish the tank 14 from time to time. Alternatively, the facility B can be coupled to a fuel line (not shown) and the fuel vendor can supply fuel directly to the facility B via the fuel line.

The utility A supplies electricity to the facility B and can be, for example, an electricity vendor such as the British Columbia Hydro and Power Authority (“BC Hydro”). “Utility” as used in this description also includes utility operators. The facility B, while diagrammed as a single facility, in practice typically represents a plurality of facilities B that can all be simultaneously supplied with power from the utility A. The server 200 can communicate with the utility A and facility B using, for example, electrical power lines as a medium or via any other suitable type of network, including a packet-switched network such as the Internet. Optionally, installed at the facility B can be a facility energy management system that is able to alternate between electrical and non-electrical (i.e.: fuel) sources of energy to provide heating to the facility B.

The facility B has a variety of heating and electrical loads, which can be summarized as follows:
Facility total electrical demand: The facility total electrical demand, measured in kW, represents the total electrical load placed on the utility A by any one facility B at any given time. The facility total electrical demand is the sum of the current heating electrical load and the current non-heating electrical load (described below) of any one facility B.
Current heating electrical load and current non-heating electrical load: The current heating electrical load is the electrical load placed on the utility A by any one facility B at any given time that is used to heat the facility B. The current non-heating electrical load is the electrical load placed on the utility A by the facility B at any given time that is used for non-heating purposes in the facility; for example, to power all non-heating electrical fixtures. Both the current heating and non-heating electrical loads are measured in kW.
Current heating non-electrical load: The current heating non-electrical load is the energy load that is used by the facility B for heating purposes, and that is not satisfied by electricity. Typically, the current heating non-electrical load is supplied by a fuel boiler or furnace that burns a fossil fuel, such as heating oil, natural gas, butane, or propane, for heat.
Facility total heating load: The facility total heating load is the sum of the current heating electrical load and the current heating non-electrical load.

Referring particularly to FIG. 1, the server 200 accepts as inputs the following signals from the facility B:
Heat Demand 206: The heat demand 206 input is a binary input that indicates whether the facility B has any demand for heat at all; i.e., it indicates whether either the current heating electrical load or the current heating non-electrical load is greater than zero.
Total Demand 207: The total demand 207, measured in Watts, represents the total instantaneous demand for electricity at any given time by the facility B.
Peak Demand 209: The peak demand 209, measured in Watts, represents the peak billed demand threshold of the facility B. The peak billed demand threshold in this embodiment is measured as the peak electrical demand of the facility B in any given billing period. When the electrical demand of the facility B exceeds the peak billed demand threshold, the utility A charges the facility B a demand charge. Typically the peak demand 209 is assigned to be the peak billed demand recorded and billed during the same month in a previous year or years; however, the peak demand 209 may be based on any historical period of time and dynamically updated to account for unexpected electrical power consumption conditions.
In a first embodiment, the peak demand 209 takes into account the electrical demand of all the electrical devices in the facility B, regardless of whether the devices consuming the electricity are used for heating.
In a second embodiment, the peak demand 209 takes into account the electrical demand of all electrical devices in the facility B, except those devices used to heat the facility, i.e. only non-heating electrical devices are considered when determining peak demand 209. The utility A could be motivated to exclude electric heating devices from the calculation of peak demand, as the peak demand fee is usually charged by the utility A to discourage customers from electrical usage that exceeds the peak billed demand threshold; as the utility valley filling algorithm uses the facility's electric heaters to consume excess produced electricity, in this embodiment the utility A could prefer to encourage instead of discourage the facility B to use electricity for heating. Excluding the electric heating devices from the calculation of peak demand can be easily implemented by the utility A by installing a separate electrical meter for the electric heating devices.
Current electric heater load 208: The current electric heater load 208, measured in Watts, is a measurement of the current heating electrical load of the facility B. Optionally, the maximum electric heater load, which represents the total power that can be consumed by the electric heating assembly 14, can also be transmitted from the facility B to the server 200. If the maximum electric heater load is not transmitted, then the server 200 can acquire this value in another manner; the server 200 can, for example, be pre-programmed with the maximum electric heater load for each facility B.
Fossil fuel heater status 210: The fossil fuel heater status 210 indicates whether the fossil fuel heating assembly 16 is on or off. Optionally, fossil fuel heater status 210 also provides some sort of measure as to how much energy the fossil fuel heating assembly 16 is consuming. The fossil fuel heater status 210 may, for example, indicate whether the fossil fuel heating assembly 16 is operating at low, medium or high fire. Optionally, a gas meter may be coupled to the fossil fuel heating assembly 16 to measure the volume of gas being used by the fossil fuel heating assembly 16. In this case, the readings of the gas meter may also be transmitted to the server 200.
Current operating temperatures 212: The current operating temperatures 212 indicate the temperature of the fluid that is heated by either the electric or fuel heating assemblies 14, 16. The current operating temperatures 212 indicate the current heating electrical load (as heated by the electric heating assembly 14) and the current heating non-electrical load (as heated by the fuel heating assembly 16).

The server 200 outputs the following signals to the facility B:
Electric heater enable 214: The heater enable 214 signal is a binary signal that indicates whether the electric heating assembly 14 in the facility B should be activated.
Target electric heater load 216: If the heater enable 214 signal is active, the target electric heater load 216 signal indicates the desired load, in kW, at which the electric heating assembly 14 will be programmed to operate. The target electric heater load 216 is the desired current heating electrical load for a particular facility B. Optionally, in lieu of sending the target electric heater load 216 signal, the server 200 may output a binary signal (e.g.: “raise” or “lower” the consumption of the electric heating assembly 14).
New peak load 217: Periodically, such as on a monthly basis, the server 200 will calculate a new peak billed demand threshold for the facility B. This new peak billed demand threshold 217 is transmitted to the facility B via the new peak load 217 signal.

The server 200 accepts as an input the following signal from the utility A:
Target load 218: The target load 218 is the desired cumulative instantaneous electrical load, in kW, that the utility A wishes to have to satisfy.

The server 200 outputs the following signals to the utility A:
Current load 220: The current load 220, measured in Watts, is set to equal the value of the total instantaneous electrical load of all the facilities B coupled to the utility A and to the server 200.
Capable load 221: The capable load 221, measured in Watts, is set to equal the total cumulative load that the facilities B can economically utilize. In an embodiment wherein electricity consumed by the electric heating assembly 14 is considered in calculating peak demand, at an extreme, the capable load 221 is the sum of the peak demand 209 over all the facilities B. In such an embodiment, if operating the electric heating assembly 14 at full capacity does not bring the total demand 207 per facility B to the peak demand 209, then the capable load 221 will be the sum of the total demand 208 across the facilities B, when the electric heating assembly 14 at each facility B is consuming the maximum amount of electricity possible.

In one embodiment, the server 200 communicates with a controller (not shown) at the facility B. The controller communicates with sensors (not shown) that measure the various electrical (both heating and non-heating) and fuel loads of the facility B. The controller also communicates with and can control the electrical and fuel heating assemblies 14, 16 such that the amount of electricity and fuel consumed by the electrical and fuel heating assemblies 14, 16, respectively, can be adjusted in accordance with the signals received from the server 200. In the embodiments considered herein, the controller at the facility B can set the consumption of the electrical heating assembly 14 to be equal to the target electric heater load 216, and accordingly set the consumption of the fuel heating assembly 16 to be the difference between the facility total heating load 20 and the target electric heater load 216. In an alternative embodiment, no controller has to be physically present at the facility B, and the electrical and fuel heating assemblies 14, 16 can be controlled remotely, such as directly using the server 200.

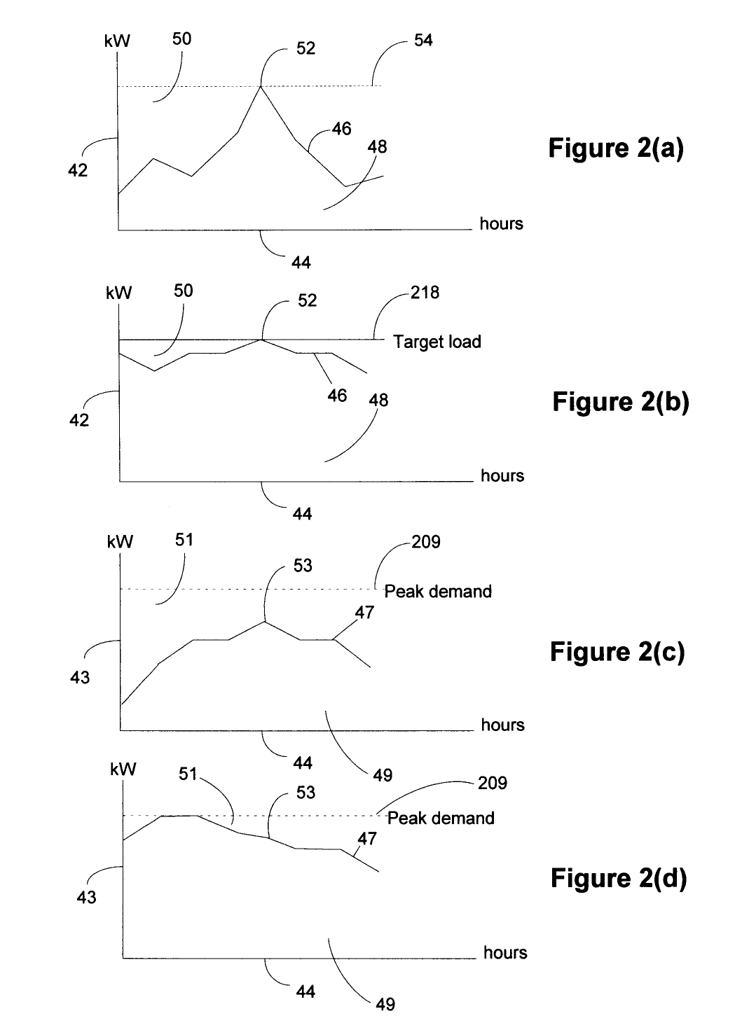

Graphically, “utility valley filling” can be understood through reference to FIGS. 2(a)-(d). FIGS. 2(a) and 2(b) represent the cumulative electrical load of all facilities B coupled to the utility A for a given period of time. The vertical axis 42 represents electrical load in kW, while the horizontal axis 44 represents the time of the day in hours, beginning at midnight and ending 24 hours later. The curve 46 represents the cumulative electrical load of all facilities B coupled to the utility A in kW, and the area 48 below the curve 46 represents the energy, in kWH, consumed by the utility A's customers.

FIG. 2(a) is an exemplary curve of cumulative electrical load of the facilities B prior to implementation of the utility valley filling algorithm. As can be seen in FIG. 2(a), the highest cumulative electrical load is represented by point 52, which represents a time of very high electrical demand. In this embodiment, the electrical output of the utility A is equal to the load at point 52, and the utility A relies on a relatively clean generation source, such as a nuclear power plant. The electrical output of such a generation source is typically constant. Consequently, the area 50 between the line 54, which has a value equal to the peak load at point 52, and the curve 46 represents the amount of energy that the utility A generates but that is not consumed by its own customers. I.e., the energy represented by the area 50 is typically sold to other utilities at significantly below-market rates.

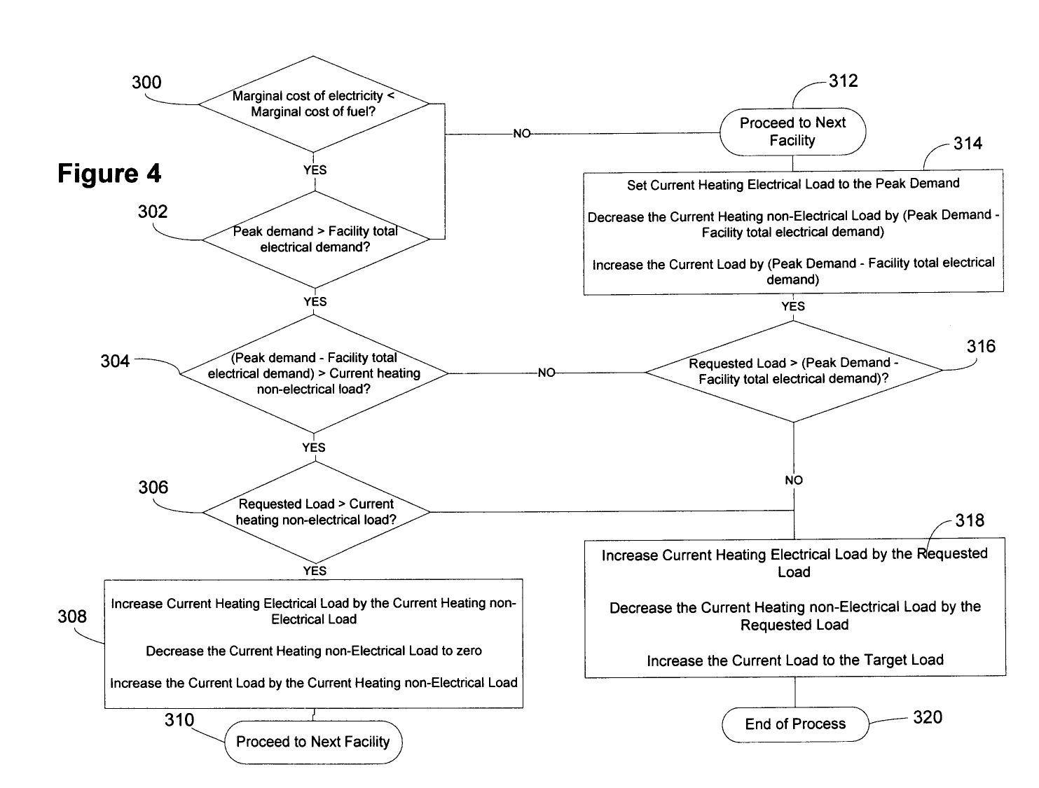

FIG. 2(b) is an exemplary curve of cumulative electrical load of the facilities B following execution of the utility valley filling algorithm. The utility valley filling algorithm, using methods such as those described below in relation to FIGS. 4-6, allows the utility A to increase the demand of its own customers such that the utility A can sell the energy represented by the area 50 to its own customers for a profit as opposed to other utilities at below-market rates. In FIG. 2(b), the target load 218 is set equal to the value of the peak load at point 52, and the electrical heating assemblies 14 of the facilities B are activated in order to increase the electrical load placed on the utility A. As is evident from FIG. 2(b), although the load satisfied by the utility A is not exactly equal to the target load 218, the energy consumed by the utility A's customers in FIG. 2(b) is significantly greater than the energy consumed by the utility A's customers in FIG. 2(a), with the difference in energy consumed representing the additional energy the utility A is able to sell to its own customers for profit as opposed to other utilities at below-market rates.

FIGS. 2(c) and 2(d) graphically represent the demand of any given facility B for a given period of time. The vertical axis 43 represents electrical load, in kW, that the facility B places on the utility A, while the horizontal axis 44 represents the time of the day in hours, beginning at midnight and ending 24 hours later. The curve 47 represents the cumulative electrical load of the facility B in kW, and the area 49 below the curve 47 represents the energy, in kWH, consumed by the facility B.

FIG. 2(c) is an exemplary curve of demand of any given facility B prior to implementation of the utility valley filling algorithm. In FIG. 2(c), the highest demand for the depicted duration is represented by point 53. The area between the peak demand 209 and the curve 47 represents the energy that the facility B can utilize to help implement the utility valley filling algorithm. The facility B is motivated to fill this valley, e.g. by operating electric heating devices, since it has already paid a peak billed demand charge based on the highest peak usage of electricity by the facility B during a billing period; any electricity used below this peak (i.e. within a valley) would not be subject to a higher peak billed demand charge. As mentioned above, the utility A is motivated to fill this valley of excess produced electricity, e.g. by having its customers purchase the electricity to heat their facilities, as the utility would otherwise have to sell the excess produced electricity at a heavily discounted price.

FIG. 2(d) is an exemplary curve of demand of any given facility B following execution of the utility valley filling algorithm. In the embodiment depicted in FIG. 2(d), electrical consumption of the electrical heating assembly 14, i.e. the current electric heating load 208, is considered when determining whether electrical consumption by the facility B exceeds the peak demand 209. As is evident by comparing FIG. 2(d) to FIG. 2(c), in an attempt to increase the total load that the utility A must satisfy, the energy consumed by the facility B following execution of the utility valley filling algorithm is much higher than the energy consumed by the facility B prior to execution of the utility valley filling algorithm. Because the current electric heating load 208 is considered in determining whether the facility B has exceeded the peak demand 209, however, at no time does the facility total electrical demand exceed the peak demand 209.

### Server Programming and System Operation

Referring now to FIG. 4, there is depicted a utility valley filling algorithm that can be executed by the server 200 to cause the customers of the utility A to purchase excess produced electricity to heat the customer facilities or for other purposes i.e., when the utility A target load 218 is greater than the current load 220/total electrical demand from all of the customer facilities B. For each facility B that is a customer of the utility A, the server 200 first compares the marginal cost of electricity against the marginal cost of a secondary fuel that can be used to operate the fuel heating assembly 16 in the facility B, such as propane (block 300). If the marginal cost of fuel is not greater than the marginal cost of electricity, then, from the point of view of the facility B, additional electricity cannot be used economically, and the server 200 should proceed to querying whether other facilities (block 312) can satisfy the demand request from the utility A.

Assuming the marginal cost of electricity is less than the marginal cost of fuel for the subject facility B, the server 200 then determines whether the facility B is currently consuming electricity at its peak demand 209 (block 302). Again, if the facility B is consuming electricity at its peak demand 209, then, from the perspective of the facility B, additional electricity cannot be used economically, and the server 200 should proceed to querying whether other facilities (block 312) can satisfy the demand request from the utility A.

In an alternative embodiment (not depicted), a maximum economic electrical load can be determined for each facility. The maximum economic electrical load is not greater than the peak demand 209 of all the facilities B that are customers of the utility A and can be set to equal the peak demand 209. However, the maximum economic electrical load can also be set to a level below the peak demand 209 so that if the facility B requires additional electrical power, that power can be supplied without the facility total electrical demand exceeding the peak demand 209.

If facility total electrical demand is less than peak demand 209 of the subject facility B, then the server 200 determines whether the difference between peak demand 209 and the facility total electrical demand is greater than the current heating non-electrical load (block 304). This means that at least some of the heating being provided by the fuel heating assembly 16 (e.g. a fuel boiler or furnace) can be replaced by heating from the electrical heating assembly 14, such as an electrical boiler or furnace, so long as the total electrical demand stays below the peak demand 209, i.e. avoids incurring a higher peak demand charge. If this difference is greater than the current heating non-electrical load, then the current heating non-electrical load could be reduced to zero (e.g. by shutting off the gas boiler or furnace), if necessary, with the current heating electrical load economically increasing by a corresponding amount, and the server 200 proceeds to block 306.

At block 306, the server 200 determines whether the “requested load” by the utility A is greater than the current heating non-electrical load of the facility B. The “requested load” is the difference between the target load 218 of the utility A and the current load 220 representing the load of all of the facilities B; the requested load (when greater than zero) therefore represents the excess produced electricity which the utility A desires to sell to its customers to heat or otherwise be used by the facilities B. If the requested load is greater than the current heating non-electrical load, then heating provided by the fuel heating assembly 16 can instead be performed by the electric heating assembly 14, which is executed by: increasing the current heating electrical load by the current heating non-electrical load; and decreasing the current heating non-electrical load to zero. Consequently, the current load 220 will increase by the current heating non-electrical load (block 308). In other words, the server 200 causes the subject facility B to heat itself by electricity instead of fuel to the extent that it is economical for the facility B to do so, thereby consuming some of the excess produced electricity and lowering the utility's requested load. If there is still excess produced electricity, there remains a requested load by the utility A, and the server 200 proceeds to a subsequent facility B (block 310) in an attempt to further meet the requested load.

If the requested load is less than the current heating non-electrical load, then the current facility B can meet the entire requested load by operating its electric heating assembly 14. The server 200 increases the current heating electrical load by the requested load, decreasing the current heating non-electrical load by the requested load. As a consequence, the requested load goes to zero and the current load 220 rises to equal target load 218. In other words, the requested load is satisfied entirely by the present facility B, and the process can therefore subsequently end (block 320).

Returning to block 304, for the subject facility B, if the difference between peak demand 209 and the facility total electrical demand is not greater than the current heating non-electrical load, then the server 200 proceeds to block 316. At block 316, the server 200 determines whether the utility's requested load is greater than the difference between peak demand and the facility total electrical demand of the subject facility B. If the requested load is not greater, then the server 200 progresses to block 318 and adjusts current heating electrical and non-electrical loads and the current load 220 as described above. If the requested load is greater, then the server 200 proceeds to block 314 and sets the current heating electrical load of the subject facility B to its peak demand 209; decreases the subject facility's current heating non-electrical load by the difference between peak demand 209 and the facility total electrical demand; and increases the utility's target load 218 by the difference between peak demand 209 and the facility total electrical demand. As block 314 does not result in the requested load being decreased to zero (i.e.: the current load 220 is not set equal to the target load 218), the server 200 proceeds to block 312 and proceeds to another facility B in an attempt to further increase demand.

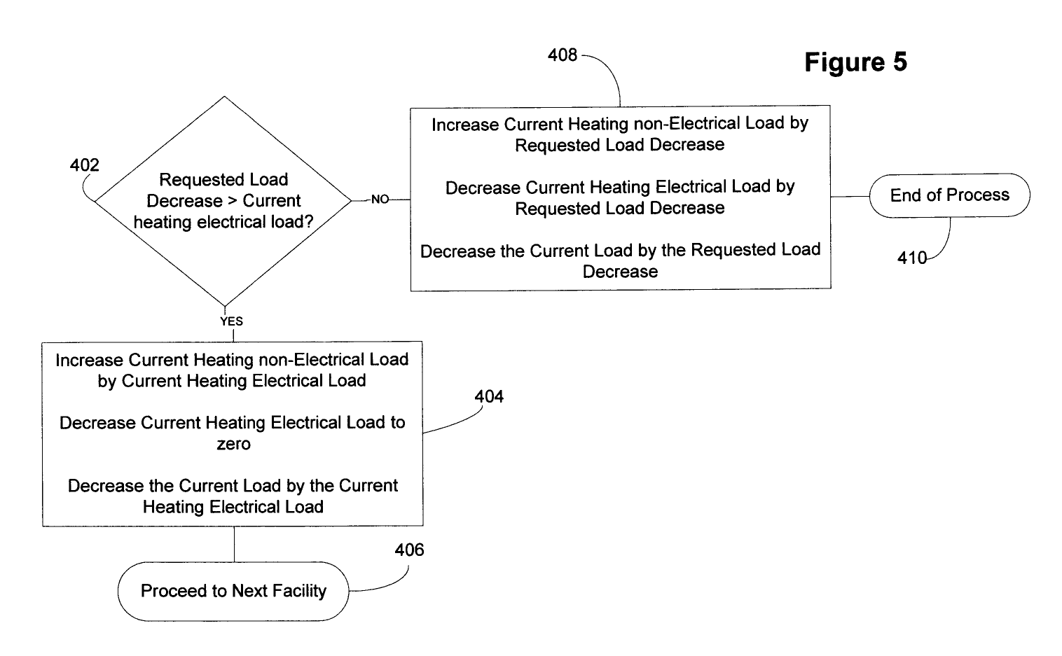

Referring now to FIG. 5, there is depicted an algorithm that can be implemented by the server 200 when the utility A desires that the current electrical load on the utility A be reduced; i.e., when the utility A requests a target load 218 less than the current load 220 such that the requested load is negative (less than zero), the utility desires the requested load deficit to be reduced to zero. At block 402, the server 200 will determine whether the requested utility current load decrease is greater than the current heating electrical load of the facility B. By “requested utility current load decrease”, it is meant the absolute value of the difference between the target load 218 and the current load 220. When the requested utility current load decrease is greater than the current heating electrical load of the subject facility B, the server 200 proceeds to block 404; otherwise, the server 200 proceeds to block 408.

If the utility's requested utility current load decrease is greater than the current heating electrical load of the subject facility B, then assuming that the capacity of the fuel heating assembly 16 of the subject facility B is sufficiently high, the entirety of the current heating electrical load can be transferred from the electric heating assembly 14 to the fuel heating assembly 16. Consequently, at block 404, the current heating non-electrical load is increased by the current heating electrical load by activating or increasing output of the fuel heating assembly 16; and the current heating electrical load is decreased to zero by de-activating the electric heating assembly 14. Consequently, the utility's current load 220 is also decreased by the facility's current heating electrical load. As the utility's requested current load decrease will still be non-zero, the utility will require other facilities to shut down or reduce output from their electric heating assemblies 14, and thus the server 200 then proceeds to another facility B (block 406) in an attempt to decrease the current load.

If the utility's requested current load decrease is not greater than the facility's current heating electrical load, then (at block 408) the facility's current heating non-electrical load is increased by the requested load decrease by activating or increasing output from the fuel heating assembly 16; the current heating electrical load is decreased by the requested load decrease by de-activating or reducing output from the electric heating assembly 14. Consequently, the current load 220 will decrease by the requested load decrease. As the requested load decrease is zero after block 408, the process can end (block 410).

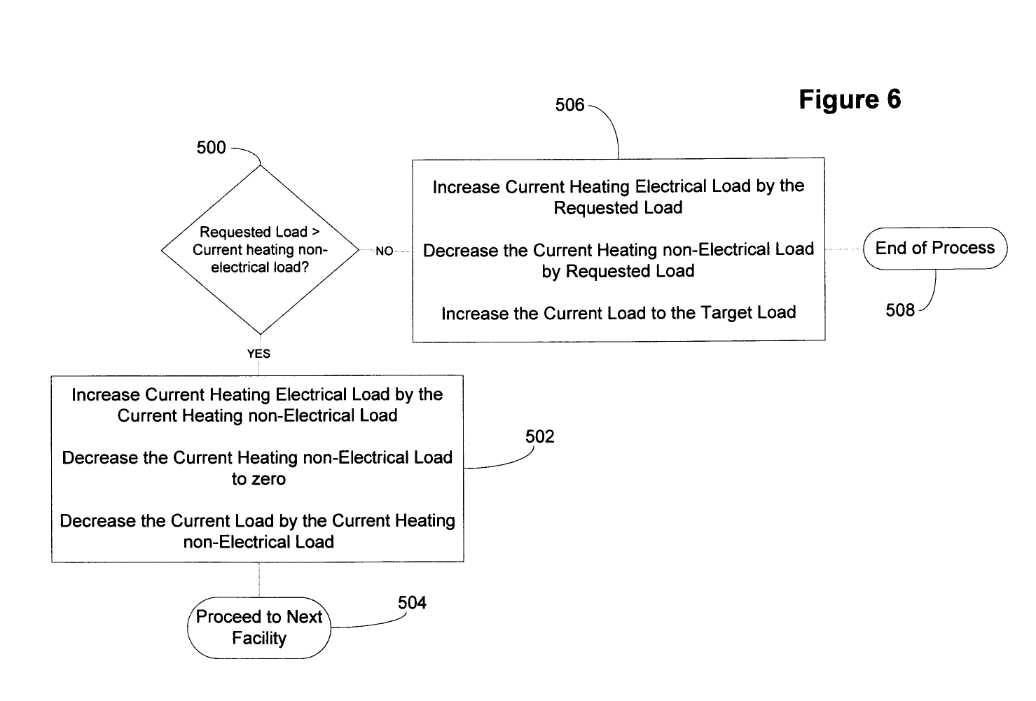

Referring now to FIG. 6, there is depicted a further embodiment of an algorithm that can be implemented by the server 200 when the utility A requests that electrical demand from the facilities B be reduced, and when electricity consumed by the electrical heating assembly 14 of each facility B is not considered when determining whether the facility B is at or above its peak billed demand threshold.

At block 500, the server 200 will determine whether the requested load from the utility A is greater than the current heating non-electrical load of the facility B. When the requested load is greater than the current heating non-electrical load, only some of the current load can be met by the electric heating assembly 14 of the subject facility B and the server 200 proceeds to block 502; otherwise, the server 200 proceeds to block 506.

If the requested load is greater than the current heating non-electrical load, then assuming that the capacity of the electric heating assembly 14 is sufficiently high, the entirety of the current heating non-electrical load can be transferred from the fuel heating assembly 16 to the electric heating assembly 14. Consequently, at block 502, the current heating electrical load is increased by the current heating non-electrical load by activating or increasing output of the electric heating assembly 14; and the current heating non-electrical load is decreased to zero by deactivating the fuel heating assembly 16. Consequently, the current load 220 is also decreased by the current heating non-electrical load. As the requested load will still be non-zero, the server 200 then proceeds to another facility B (block 504) in an attempt to increase electrical demand from the facility B to meet the utility's requested load.

If the requested load is not greater than the current heating non-electrical load, then the electricity consumption of the electrical heating assembly 14 can be increased to meet all of the requested load, and (at block 506) the current heating electrical load is increased by the requested load by increasing the electrical output of the heating assembly 14; and the current heating non-electrical load is decreased by the requested load by deactivating or reducing output of the fuel heating assembly 16. Consequently, the utility's current load 220 is increased by the requested load. As the requested load is zero after block 506, the process can end (block 510). Of note, the server 200 does not factor whether adjusting the electrical and fuel usage of the facilities is economical to the facilities, and only bases its decisions on carrying out the most economical course of action from the perspective of the utility A.

Optionally, any increase (or decrease) in the target load can be apportioned equally between a plurality of facilities B to which the server 200 and the utility A are coupled. Alternatively, if any particular one of the facilities B is incapable of accepting the entirety of its portion of a load increase, the load for that particular facility may be increased to the greatest extent possible, with any excess load assigned to one of or apportioned amongst the remaining facilities.

The server 200 may execute the utility valley filling algorithm from time to time, such as every few seconds, refreshing the values of the various signals used in executing the algorithm each time in order to ensure that the algorithm is consistently being implemented using up-to-date and accurate values.

According to a further embodiment, there is provided a computer readable medium, such as random access and read only memories and various disc-based media, each having encoded thereon the aforedescribed steps and instructions. This medium is accessed by a server or other computing device which is communicative with the utility A and its facilities B and can control the operation of the electric and fuel heaters in the facilities B. The medium can be installed on the computing device directly, or be located remotely from the computing device in a separate computer and communicative with the computing device by known networking means.

According to yet another embodiment, the server 200 is programmed to execute the valley filling algorithm such that the facility B is operated to provide a spinning reserve to the utility A. A spinning reserve is any back-up energy production capacity which is made available to a utility within short notice e.g. 10 minutes, and can be operated continuously for a defined length of time, e.g. at least two hours. The server has an additional input (not shown) communicative with the utility A which receives a request from the utility A for spinning reserve. The utility valley filling algorithm stored on the memory of the server and executed by the processor of the server is modified so that when a request for spinning reserve is received from the utility A, the server 200 sends a control signal to the electrical heating assembly 14 to reduce the current heating electrical load by the requested spinning reserve, and sends another signal to the non-electrical heating assembly 16 to increase the current heating non-electrical load by the same amount. To ensure that the there is sufficient capacity to meet the maximum contracted spinning reserve of the utility A, the utility valley filling algorithm can be modified so that electrical heating assembly 14 is operate at a current heating electrical load that is always at least as high as the contracted spinning reserve.

One practical effect of the above is that the utility A is able to “dispatch demand” as it is able to “dispatch generation”. Utilities A dispatch generation by increasing and decreasing power generation as required in response to demand. “Dispatching demand” is akin to dispatching generation in reverse. If the utility A must satisfy more demand than it has supply, in addition or as an alternative to “dispatching generation”, the utility A could “dispatch demand” by reducing demand according to the algorithm discussed in relation to FIG. 5, for example. Similarly, if the utility A has more supply than demand, in addition or as an alternative to reducing generation, the utility A could “dispatch demand” by increasing demand according to the algorithms discussed in relation to FIGS. 4 and 6, for example.

In contrast to peak shaving, one benefit of utility valley filling is ease of application, in that consumers can relatively inexpensively buy an electric boiler, for example, for use during periods of low demand. When utility valley filling results in an increase in demand for electricity during periods of otherwise low demand, greenhouse gas emissions from the facility will be reduced as fossil fuel usage will be displaced by increased electricity usage.

A second benefit of utility valley filling is that, as opposed to peak shaving wherein a utility must pay consumers, a utility can make money using utility valley filling, as it can sell power to its own consumers in excess of the price the power would otherwise fetch on the open market during a period of low demand. A third benefit of utility valley filling is that consistent utility valley filling can result in an increased “base electrical load”, or minimum amount of power that is consistently utilized by facilities. Instead of using inefficient means of power generation, such as expensive gas turbine equipment, to satisfy periodic spikes in load, a utility that has to satisfy a significantly increased base electrical load can instead use cleaner (i.e.: reduced greenhouse gas emissions) and less expensive means of electricity generation, such as nuclear or wind power. One result of this is that when base electrical load is increased, fossil fuel usage by the facility is decreased, and an overall drop in greenhouse gas emissions results. An overall drop in greenhouse gas emissions results because not only does the facility reduce its fossil fuel consumption, but such reduction in fossil fuel use is offset by increased electricity consumption that is produced using a relatively clean form of generation.

A fourth benefit of utility valley filling is that it can make unpredictable, variable output sources of electricity, such as wind power, economically viable. A wind turbine, for example, may generate a great deal of power when the demand for electricity and the price a utility can charge for electricity are low, and also may generate hardly any power when the demand for and price of electricity are high. Consequently, such variable output sources are often not attractive to utilities. A utility that can increase or reduce the demand it must satisfy as desired would be able to increase demand for electricity during periods of otherwise low demand and decrease demand for electricity during periods of otherwise high demand, thereby making economical such unpredictable, variable output sources of electricity.

A fifth benefit of utility valley filling wherein the electrical heating assembly 14 and the fuel heating assembly 16 are used to heat the facility B is that regardless of changes in how the heating load is apportioned between the electrical heating assembly 14 and the fuel heating assembly 16, the facility total heating load 20 can remain constant. Consequently, from the facility B's point of view, a change in the electrical consumption of the electrical heating assembly 14 because of a change in the needs of the utility A does not negatively affect the total amount of heating provided to the facility B, since the fuel heating assembly 16 is able to compensate for changes in the heating output of the electrical heating assembly 14. In prior art methods such as “peak shaving”, referenced above, reducing the electrical load of the facility B means that certain electrical devices or services must be shut down and that operations at the facility B suffer as a result, as no alternative energy source is available to compensate for the decrease in electricity from the utility A. According to the present embodiments, not only can the fuel heating assembly 16 compensate for changes in output of the electrical heating assembly 14, but the fuel heating assembly 16 is able to respond quickly enough such that users do not notice any change in electrical load at all.

### Example of Operation

### Dispatching Demand in an Automatic Generation Control System

As mentioned above, one use of the aforedescribed embodiments is to “dispatch demand” instead of “dispatch generation”. Conventionally, one scenario in which the utility A has been forced to “dispatch generation” is when the power output of electric generators within a jurisdiction (“Jurisdiction”) deviates from the amount of load in the Jurisdiction. For example, in Ontario, Canada, the Independent Electric System Operator (“IESO”) is responsible for calculating the market price of electricity and for overseeing the purchase and sale of electricity within Ontario. Every five minutes, the IESO calculates a new market price for electricity by balancing the supply of electricity with the projected demand for electricity over the following five minute interval. As supply is balanced against projected demand, there are necessarily deviations between the supply of electricity and the actual demand in the five minute interval; these deviations are collectively referred to as “Area Control Error”. An Automatic Generation Control System (“AGC System”) monitors the Area Control Error and accordingly dispatches generation in response to it. If supply exceeds load, generation is reduced; conversely, if supply is less than load, generation is increased. Matching supply and load is important because if supply drops below load, relatively expensive electricity will flow into the Jurisdiction via “tie lines”, which electrically couple the Jurisdiction to neighbouring jurisdictions, and because the system frequency within the Jurisdiction will fall below a preset threshold (60 Hz in Ontario). Conversely, if supply exceeds load, electricity will flow out of the Jurisdiction via the tie lines at a loss, and system frequency will exceed the preset threshold.

In order to be able to increase and decrease generation as required, the utility A can contract to have generated for it a specific amount of power (“AGC Additional Generation”). In Ontario, for example, the IESO contracts with various electricity suppliers to generate for it up to 150 MW of AGC Additional Generation. In order to be able to increase and decrease supply as required, the AGC System may be configured to consistently use 75 MW of this power, such that generation can be increased (in which case some of the electricity supplier's remaining generation capacity is utilized) or decreased (in which case the electricity suppliers are instructed to generate less power) by as much as 75 MW.

As discussed above, generating the AGC Additional Generation is typically expensive and may be done with relatively heavily polluting forms of generation (e.g.: gas turbines). Electricity generated in this fashion can easily cost at least $0.10-$0.15/kWh. This is in contrast to what is a typical average price of electricity in the Jurisdiction; in Ontario, for example, the typical average price of electricity can be approximately $0.054/kWh.

Instead of the utility A contracting to have expensive electricity generated such that it can “dispatch generation”, the aforedescribed embodiments can be used to control the load of the facilities B within the Jurisdiction, i.e. to “dispatch demand” to the facilities B, thereby resulting in a much more inexpensive and less polluting way of ensuring that generation matches load. Notably, such an application of “dispatchable demand” differs from increasing the base electrical load such that the difference between the base electrical load and the peak electrical load is reduced. The AGC System can “dispatch demand” to help ensure that supply meets load and to reduce Area Control Error regardless of the difference between the base electrical load and the peak electrical load.

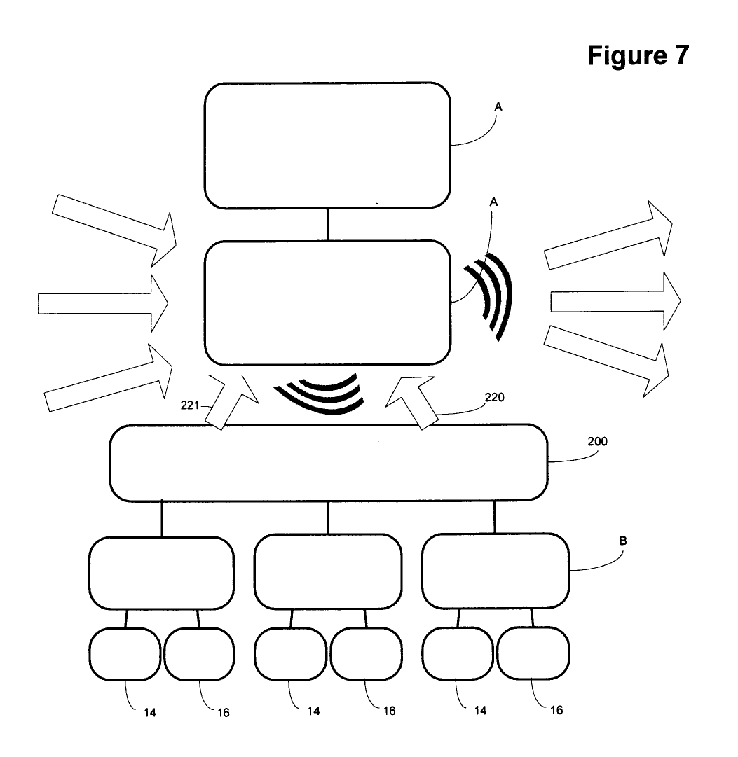

Referring now to FIG. 7, there is depicted the utility A that includes a Power System Control Centre (“PSCC”) and an AGC System (labelled “Generation Control System”) within the Jurisdiction. The PSCC may be any entity that oversees the electricity markets in the Jurisdiction. An example of a PSCC is the IESO. The PSCC also manages the AGC System.

In FIG. 7, the server 200 is communicative with the utility A and a series of facilities B and can be used to implement the algorithms depicted in FIGS. 4-6 in order to “dispatch demand” to facilities B so as to satisfy the needs of the AGC System in lieu of purchasing AGC Additional Generation. The facilities B can be composed of, for example, hotels, schools, offices and hospitals. As described above, each of the facilities B can have installed therein the electrical and fuel heating assemblies 14, 16, which consume electricity and fuel (such as natural gas), respectively, in order to heat the heatable fluid 18 (such as domestic hot water, or DHW). Notably, although this particular embodiment references the electrical heating assembly 14, any electrical device that consistently and reliably requires electricity can be used as source of electrical demand. Battery chargers for plug-in hybrid electric vehicles and apparatuses for hydrogen production (e.g.: via electrolysis) can also be used as sources of demand.

Assuming that each facility B utilizes the electrical and fuel heating assemblies 14, 16 to heat DHW, then from the facility B's point of view it can be shown that replacing a single fuel boiler with the pair of electrical and fuel heating assemblies 14, 16 coupled to the server 200 executing the utility valley filling algorithm is an economically wise choice. For example, presume that natural gas is the fuel used by the fuel heating assembly 16 and that the price of fuel is approximately $10/GJ. Also presume that the facility B purchases electricity at a cost of approximately $0.02/kWh (or roughly $5.60/GJ). Then, as indicated in Table 1 below, for a 300 kW electric heating assembly 14 the facility B will have recouped its installation costs in 5 years:

TABLE 1
Cost Savings

| SYSTEM | | RESULTS | | |
|---|---|---|---|---|
| Boiler Size | 300 kW | Annual Added Elec | 1,445,400 | kWh |
| Installation Cost | $250,000 | Annual Reduced Gas | 7,845 | GJ |
| Run Time | 55% | Annual Added Elec Cost | $28,908 | |
| Elec Price | $0.02/kWh | Annual Reduced Gas Cost | $78,452 | |
| Elec Efficiency | 98% | SAVINGS | $49,544 | |
| Natural Gas Rate | $10/GJ | Pay Back | 5.0 | Yrs |

| | |
|---|---|
| Natural Gas Efficiency | 65% |

As mentioned above, a typical average price of the electricity used to meet the base electrical load within the Jurisdiction is $0.054/kWh. The utility A can purchase electricity at this price in sufficient quantities to satisfy 75 MW in load of the electrical heating assemblies 16 of the facilities B and then resell it to the facilities B at the price of $0.02/kWh, as noted above. Consequently, the net cost to the utility A for the electricity is $0.034/kWh, which is significantly cheaper than the $0.10-$0.15/kWh that is typically paid for AGC Additional Generation.

In a conventional system wherein AGC Additional Generation is used in order to equate generation and load, generation is increased when load increases and generation is decreased when load decreases. In a system wherein as much as 150 MW of AGC Additional Generation is available, typically 75 MW of baseline AGC Additional Generation is purchased at $0.10-$0.15/kWh. If load in the electrical grid rises and more generation is needed, additional AGC Additional Generation can be purchased at this price; if load in the electrical grid falls and less generation is needed, less than 75 MW of the AGC Additional Generation can be used, at a savings of $0.10-$0.15/kWh.

In contrast, when using the server 200 to “dispatch demand” to the facilities B according to the present embodiment, the utility A can purchase 75 MW at a net price of $0.034/kWh. If load in the electrical grid rises, the server 200 can instruct the electrical heating assemblies 14 of the facilities B to decrease their electricity usage by the amount load has risen in the rest of the electrical grid. In this way, this additional load can be satisfied from the electricity that would otherwise have been used by the facilities B for heating. If, for example, the current load 220 on the utility A has just risen by 15 MW, the target load 218 of the utility A will decrease by 15 MW, as the utility A will want to decrease electricity usage of the electrical heating assemblies 14 of the facilities B so as to be able to satisfy the sudden increase in load placed on the electrical grid by other users in the Jurisdiction. The “requested load decrease” can then be set to 15 MW, as discussed in respect of FIG. 4. The electricity can be sold to these other users at the current market price, thereby saving the utility A the difference between the current market price and the price of $0.02/kWh that the facilities B would pay for the electricity. Similarly, if load in the electrical grid falls, the utility A can “dispatch” this demand to the facilities B and sell electricity equivalent to this dispatched demand to the facilities B at the price of $0.02/kWh. If, for example, the current load 220 on the utility A has just fallen by 15 MW, the target load 218 of the utility A will increase by 15 MW, as the utility A will want to increase electricity usage of the electrical heating assemblies 14 of the facilities B so as to alleviate the sudden decrease in load removed from the electrical grid by other users in the Jurisdiction. The “requested load” can then be set to 15 MW, as discussed in respect of FIG. 6.

Practically, in order to provide redundancy and to increase reliability, multiple servers 200 can be used to control various groups of facilities. Electric heating assemblies 14 can be installed having typical capacities of 300 kW to 2 MW.

While particular embodiments have been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiment.

1. A method of managing energy supplied by an electric utility to a customer facility that is heatable by electrical and non-electrical heating means, comprising:
(a) determining a desired cumulative instantaneous electrical load of the utility (“target load”);
(b) determining a total instantaneous electrical load on the utility imposed by the facility (“current load”);
(c) determining a requested load from the utility as the difference between the target load and current load;
(d) when the requested load is positive, increasing heating of the facility by the electrical heating means to meet at least part of the requested load, and decreasing heating of the facility by the non-electrical heating means; and
(e) when the requested load is negative, decreasing heating of the facility by the electrical heating means to reduce at least part of a requested load deficit, and increasing heating of the facility by the non-electrical heating means.

2. A method as claimed in claim 1 wherein an electrical output of the utility is set to equal a peak load on the utility imposed by the facility in a selected time period, and the target load is set to equal the peak load.

3. A method as claimed in claim 1 further comprising determining a marginal cost of heating the facility by electrical heating means and a marginal cost of heating the facility by non-electrical heating means, and increasing the heating of the facility by the electrical heating means only when the marginal cost of heating by the non-electrical heating means is greater than the marginal cost of heating by the electrical heating means.

4. A method as claimed in claim 3 further comprising determining a peak billed demand threshold of the facility in a selected billing period and a total electrical demand of the facility and increasing the heating of the facility by the electrical heating means only when the total electrical demand of the facility is less than the peak billed demand threshold of the facility.

5. A method as claimed in claim 4 wherein all electrical consumption by the facility contributes to determining the peak billed demand threshold of the facility.

6. A method as claimed in claim 4 wherein only electrical consumption by the facility for non-heating purposes contributes to determining the peak billed demand threshold.

7. A method as claimed in claim 1 wherein increasing heating of the facility by the electrical heating means increases a current heating electrical load of the facility by at least a portion of the requested load, and decreasing heating of the facility by the non-electrical heating means decreases a current heating non-electrical load of the facility, the method further comprising when the requested load is greater than the current heating non-electrical load of the facility:
(a) increasing heating of the facility by the electrical heating means thereby increasing the current heating electrical load of the facility by the current heating non-electrical load; and
(b) decreasing heating of the facility by the non-electrical heating means thereby decreasing the current heating non-electrical load to zero.

8. A method as claimed in claim 7 further comprising when the requested load is not greater than the current heating non-electrical load:
(a) increasing heating of the facility by the electrical heating means thereby increasing the current heating electrical load by the requested load; and
(b) decreasing heating of the facility by the non-electrical heating means thereby decreasing the current heating non-electrical load by the requested load.

9. A method as claimed in claim 8 wherein determining whether the requested load of the utility is greater than the current heating non-electrical load of the facility is performed only when the difference between a peak billed demand threshold and the facility total electrical demand is greater than the current heating non-electrical load.

10. A method as claimed in claim 9 further comprising
(a) when the difference between the peak billed demand threshold and the facility total electrical demand is not greater than the current heating non-electrical load, determining whether the requested load is greater than a difference between the peak billed demand threshold and the current heating electrical load; and then
(b) when the requested load is greater than the difference between the peak billed demand threshold and the current heating electrical load:
(i) increasing heating of the facility by the electrical heating means thereby increasing the current heating electrical load to the peak billed demand threshold; and
(ii) decreasing heating of the facility by the non-electrical heating means thereby decreasing the current heating non-electrical load by the difference between the peak billed demand threshold and the current heating electrical load.

11. A method as claimed in claim 10 further comprising when the requested load is not greater than the difference between the peak billed demand threshold and the current heating electrical load:
(i) increasing heating of the facility by the electrical heating means thereby increasing the current heating electrical load by the requested load; and
(ii) decreasing heating of the facility by the non-electrical heating means thereby decreasing the current heating non-electrical load by the requested load.

12. A method as claimed in claim 11 wherein determining whether the difference between the peak billed demand threshold and the facility total electrical demand is greater than the current heating non-electrical load is performed only when the peak billed demand threshold is greater than the facility total electrical demand.

13. A method as claimed in claim 12 wherein determining whether the peak billed demand threshold is greater than the facility total electrical demand is performed only when a marginal cost of electricity is less than a marginal cost of fuel.

14. A computer readable storage having encoded thereon instructions for execution on a processor to manage energy supplied to a facility by an electric utility, the instructions for performing the following method:
(a) determining a desired cumulative instantaneous electrical load of the electric utility (“target load”);
(b) determining a total instantaneous electrical load on the utility imposed by the facility (“current load”);
(c) determining a requested load from the electric utility as the difference between the target load and current load;
(d) when the requested load is positive, increasing heating of the facility by an electrical heating means to meet at least part of the requested load, and decreasing heating of the facility by a non-electrical heating means; and
(e) when the requested load is negative, decreasing heating of the facility by the electrical heating means to reduce at least part of a requested load deficit, and increasing heating of the facility by the non-electrical heating means.

15. A system for managing energy supplied by an electric utility to a customer facility, comprising:
a server having
inputs communicative with the facility to receive a total instantaneous electrical demand of the facility, and communicative with the utility to receive a desired cumulative electrical load of the utility,
a processor communicative with the inputs and having a memory having recorded thereon statements and instructions for execution by the processor to perform a method comprising:
(a) determining a desired cumulative instantaneous electrical load of the electric utility (“target load”);
(b) determining a total instantaneous electrical load on the electric utility imposed by the facility (“current load”);
(c) determining a requested load from the electric utility as the difference between the target load and current load;
(d) when the requested load is positive, increasing heating of the facility by an electrical heating means to meet at least part of the requested load, and decreasing heating of the facility by a non-electrical heating means; and
(e) when the requested load is negative, decreasing heating of the facility by the electrical heating means to reduce at least part of a requested load deficit, and increasing heating of the facility by the non-electrical heating means;
outputs communicative with the facility to control heating of the facility by the non-electrical means and electrical heating means.

16. A system as claimed in claim 15 wherein the utility includes an automatic generation control system and the server inputs are communicative with the utility to receive an area control error from the automatic generation control system, and the processor is programmed to determine a target load of the utility from the area control error and perform the method to control the heating of the facility by the electrical heating means to meet any additional generation required by the automatic generation control system.

17. A method of providing a spinning reserve to an electric utility having a customer facility that is heatable by electrical and non-electrical heating means, comprising:
(a) heating the facility by the electrical heating means using electricity from the utility at a current heating electrical load that is at least as high as a maximum selected spinning reserve;
(b) receiving a spinning reserve request from the utility; and
(c) decreasing heating of the facility by the electrical heating means until the current heating electrical load is decreased by the requested spinning reserve, and increasing heating of the facility by the nonelectrical heating means.
